(19) United States
(12) Patent Application Publication
(10) Pub. No.: US 2022/0067608 A1
(43) Pub. Date: Mar. 3, 2022

(54) METHOD AND A SYSTEM FOR CREATING AND DYNAMICALLY TRACKING A PROCESS PLAN

(71) Applicant: Prama, Inc., Louisville, KY (US)

(72) Inventor: Srinivasa Raju Eedarapalli, Louisville, KY (US)

(73) Assignee: Prama, Inc.

(21) Appl. No.: 17/446,156

(22) Filed: Aug. 26, 2021

Related U.S. Application Data
(60) Provisional application No. 63/070,289, filed on Aug. 26, 2020.

(51) Int. Cl. G06Q 10/06; G06F 40/169; G06F 3/0484; G06F 3/0482; G06F 16/16

(52) U.S. Cl. CPC G06Q 10/06312; G06F 40/169; G06F 16/164; G06F 3/0482; G06F 3/0484

(57) ABSTRACT

The invention relates to method and system for creating a process plan. The method includes receiving an input to create a process entity via a first User-interface; creating a node corresponding to the process entity via a second User-Interface; dynamically receiving an attribute associated with a selected entity via the first User-interface; annotating a node corresponding to the selected entity based on the attribute received via the second User-interface; dynamically creating a link between a first node and a second node in the nodal network via the second User-Interface by receiving a selection of the first node via the second User-Interface, receiving a selection of the second node via the second User-Interface, generating the link between the first node and the second node, receiving a direction input associated with the link via the second User-Interface, and defining the direction of the link between the first node and the second node.

### CROSS REFERENCE TO RELATED APPLICATIONS

The present application claims priority to U.S. Provisional Application No. 63/070,289 filed on Aug. 26, 2020 titled “A METHOD AND A SYSTEM FOR CREATING AND DYNAMICALLY TRACKING A PROCESS PLAN.” This provisional patent application is incorporated by reference for all that is disclosed and taught therein.

### TECHNICAL FIELD

Generally, the invention relates to data visualization. More specifically, the invention relates to a method and a system for creating and dynamically tracking a process plan.

### BACKGROUND

A business typically involves producing and selling of goods and services with an aim of making long-term or short-term profits. Further, the business may be to assist a consumer in achieving a goal which may in turn generate revenue. Currently, some business modeling tools are available that may provide an approach for a user (for example, an individual, a company, or an organization) to create a business model (i.e., a blueprint). These business modeling tools may provide the user an option to create aims/goals, for example, a goal of reaching market sustenance, or a goal of meeting a specific revenue generation figure. Some business modeling tools may provide the user a facility to monitor execution of an individual goal or an individual task Other business modeling tools may provide an option of defining a set of sub-goals and tasks for a goal in order to achieve the goal. However, it may not be always possible to track execution of the different sub-goals or tasks related to a goal.

### SUMMARY

In one embodiment, a method for creating a process plan is disclosed. The method may include receiving an input to create a process entity via a first User-interface. It should be noted that the process entity may be one of a goal-type entity, an interaction-type entity, a process-type entity, a responsibility-type entity, a role-type entity, a task-type entity, and a team-type entity. The method may further include creating a node corresponding to the process entity via a second User-Interface. It should be noted that the node may be one of a goal-type node, an interaction-type node, a process-type node, a responsibility-type node, a role-type node, a task-type node, and a team-type node. The second User-Interface may include a plurality of nodes. The method may further include dynamically receiving, via the first User-interface, an attribute associated with a selected entity. The method may further include annotating, via the second User-interface, a node corresponding to the selected entity based on the attribute received. The method may further include dynamically creating, via the second User-Interface, a link between a first node and a second node in the nodal network. It should be noted that creating the link may include receiving, via the second User-Interface, a selection of the first node; receiving, via the second User-Interface, a selection of the second node; generating the link between the first node and the second node; receiving, via the second User-Interface, a direction input associated with the link; and defining the direction of the link between the first node and the second node.

In another embodiment, a system for creating a process plan is disclosed. The system may include a processor and a memory communicatively coupled to the processor. The memory may store processor-executable instructions, which, on execution, may cause the processor to receive, via a first User-interface, an input to create a process entity. It should be noted that the process entity may be one of a goal-type entity, an interaction-type entity, a process-type entity, a responsibility-type entity, a role-type entity, a task-type entity, and a team-type entity. The processor-executable instructions, on execution, may further cause the processor to create, via a second User-Interface, a node corresponding to the process entity It should be noted that the node may be one of a goal-type node, an interaction-type node, a process-type node, a responsibility-type node, a role-type node, a task-type node, and a team-type node. The second User-Interface may include a plurality of nodes. The processor-executable instructions, on execution, may further cause the processor to dynamically receive, via the first User-interface, an attribute associated with a selected entity. The processor-executable instructions, on execution, may further cause the processor to annotate, via the second User-interface, a node corresponding to the selected entity based on the attribute received. The processor-executable instructions, on execution, may further cause the processor to dynamically create, via the second User-Interface, a link between a first node and a second node in the nodal network. It should be noted that creating the link may include receiving, via the second User-Interface, a selection of the first node; receiving, via the second User-Interface, a selection of the second node; generating the link between the first node and the second node; receiving, via the second User-Interface, a direction input associated with the link; and defining the direction of the link between the first node and the second node.

In yet another embodiment, a non-transitory computer-readable medium storing computer-executable instruction for creating a process plan is disclosed. The stored instructions, when executed by a processor, may cause the processor to perform operations including receiving, via a first User-interface, an input to create a process entity. It should be noted that the process entity may be one of a goal-type entity, an interaction-type entity, a process-type entity, a responsibility-type entity, a role-type entity, a task-type entity, and a team-type entity The operations may further include creating, via a second User-Interface, a node corresponding to the process entity. It should be noted that the node may be one of a goal-type node, an interaction-type node, a process-type node, a responsibility-type node, a role-type node, a task-type node, and a team-type node. The second User-Interface may include a plurality of nodes. The operations may further include dynamically receiving, via the first User-interface, an attribute associated with a selected entity. The operations may further include annotating, via the second User-interface, a node corresponding to the selected entity based on the attribute received. The operations may further include dynamically creating, via the second User-Interface, a link between a first node and a second node in the nodal network. It should be noted that creating the link may include receiving, via the second User-Interface, a selection of the first node; receiving, via the second User-Interface, a selection of the second node; generating the link between the first node and the second node; receiving, via the second User-Interface, a direction input associated with the link; and defining the direction of the link between the first node and the second node.

It is to be understood that both the foregoing general description and the following detailed description are exemplary and explanatory only and are not restrictive of the invention, as claimed.

### BRIEF DESCRIPTION OF THE DRAWINGS

The present application can be best understood by reference to the following description taken in conjunction with the accompanying drawing figures, in which like parts may be referred to by like numerals.

FIG. 1 illustrates a block diagram of an exemplary system in a network environment for creating and dynamically tracking a process plan, in accordance with some embodiments of the present disclosure.

FIG. 2A illustrates a functional block diagram of various modules within memory of process plan creation tracking device, in accordance with some embodiments of the present disclosure.

FIG. 2B illustrates a block diagram of a system for creating and modifying an occupational model, in accordance with another embodiment of the present disclosure.

FIG. 3 illustrates a flowchart of a method for creating and dynamically tracking a process plan, in accordance with some embodiments of the present disclosure.

FIG. 4 illustrates a flowchart of a method for creating and updating an entity dataset, in accordance with some embodiments of the present disclosure.

FIG. 5 illustrates a flowchart of a method for storing position data, in accordance with some embodiments of the present disclosure.

FIG. 6 illustrates a flowchart of a method for providing secure access to nodes, in accordance with some embodiments of the present disclosure.

FIG. 7 illustrates a flow diagram of a method for creating and displaying an occupational model, in accordance with some embodiments of the present disclosure.

FIGS. 8A-8E illustrate exemplary user interfaces for displaying an occupational model, in accordance with some embodiments of the present disclosure;

FIGS. 9A-9B illustrate a user interface representing a process plan, in accordance with some embodiments of the present disclosure.

FIGS. 10A-10B illustrate exemplary interactive interfaces for receiving consumer information, in accordance with some embodiments of the present disclosure.

FIG. 11 illustrates a flow diagram of a method for modifying an occupational model, in accordance with some embodiments of the present disclosure.

FIG. 12 illustrates an exemplary interactive interface for providing a set of additional inputs to an occupational model, in accordance with some embodiments of the present disclosure.

FIG. 13 illustrates an exemplary interactive interface for providing details of one of the set of additional inputs in an occupational model, in accordance with some embodiments of the present disclosure.

### DETAILED DESCRIPTION OF THE DRAWINGS

The following description is presented to enable a person of ordinary skill in the art to make and use the invention and is provided in the context of particular applications and their requirements. Various modifications to the embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and devices are shown in block diagram form in order not to obscure the description of the invention with unnecessary detail. Thus, the present invention is not intended to be limited to the embodiments shown, but is to be accorded the widest scope consistent with the principles and features disclosed herein.

While the invention is described in terms of particular examples and illustrative figures, those of ordinary skill in the art will recognize that the invention is not limited to the examples or figures described. Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic and/or an appropriate combination thereof, as would be recognized by one skilled in the art to carry out the recited functions.) Software and firmware can be stored on computer-readable storage media. Some other processes can be implemented using analog circuitry, as is well known to one of ordinary skill in the art. Additionally, memory or other storage, as well as communication components, may be employed in embodiments of the invention.

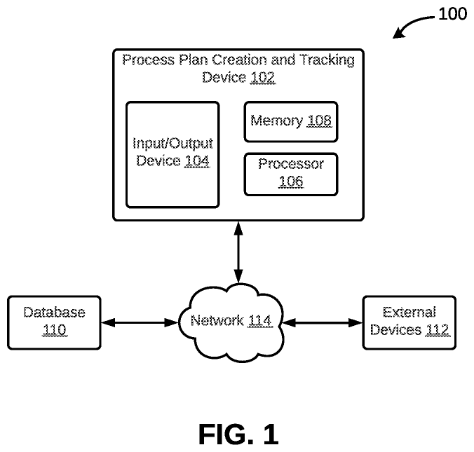

Referring to FIG. 1, a block diagram of system 100 for creating and dynamically tracking process plan is illustrated, in accordance with some embodiments of the present disclosure. In some embodiments, the process plan may correspond to an occupational model or an executable business model. The system 100 may include process plan creation and tracking device 102 with processing capabilities for monitoring progress of a primary goal associated with a business. The primary goal for a business may correspond to a core reason behind business existence, which in turn, may be responsible for providing monetary benefits. Additionally, the process plan creation and tracking device 102 may have the processing capability to drive a run-time execution of the business model. Examples of the process plan creation and tracking device 102 may include, but are not limited to, a server, a desktop, a laptop, a notebook, a net book, a tablet, a Smartphone, or a mobile phone.

The process plan creation and tracking device 102 may include an input/output (I/O) device 104. The I/O device 104 may capture information and data, for processing, and displaying a processed output. The I/O device 104 may include, but is not limited to, a keyboard, a mouse, a microphone, a scanner, a joystick, a monitor, a digital screen, and a printer. By way of an example, the I/O device 104 may be used to display results of analysis performed by process plan creation and tracking device 102, to the user. By way of another example, the I/O device may be used by the user to provide inputs to the process plan creation and tracking device 102. Thus, for example, in some embodiments, the process plan creation and tracking device 102 may ingest information such as an input to create a process entity, and attributes associated with an entity via a first user interface (not shown in FIG. 1). Further, the process plan creation and tracking device 102 may receive inputs such as, selection of nodes, and direction input via a second user interface (not shown in FIG. 1). Further, for example, in some embodiments, the process plan creation and tracking device 102 may render results to the user/administrator via the first user interface.

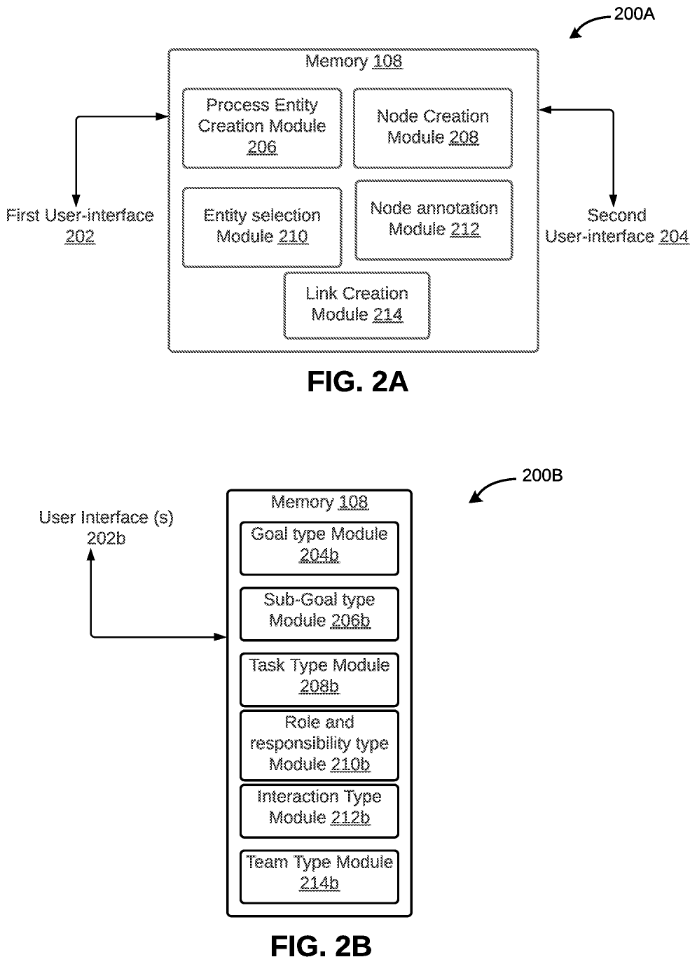

The process plan creation and tracking device 102 may further include a processor 106, which may be communicatively coupled to a memory 108. The memory 108 may store process instructions, which when executed by processor 106 may cause the processor 106 to identify functionalities performed in order to achieve the primary goal. As will be described in greater detail in conjunction with FIG. 2 to FIG. 8, in order to create a process plan, the processor 106 in conjunction with the memory 108 may perform various functions including receiving an input via a first user interface, creating nodes, receiving attributives, entity selection, annotating nodes, and creating links between the nodes.

The memory may store various data (for example, plurality of nodes and associated metadata, position data, link data, direction data, user details, and the like) that may be captured, processed, and/or required by the process plan creation and tracking device 102. The memory 108 may be a non-volatile memory or a volatile memory. Examples of non-volatile memory may include, but are not limited to a flash memory, a Read Only Memory (ROM), a Programmable ROM (PROM), Erasable PROM (EPROM), and Electrically EPROM (EEPROM) memory. Examples of volatile memory may include, but are not limited to, Dynamic Random-Access Memory (DRAM), and Static Random-Access memory (SRAM). Moreover, the process plan creation and tracking device 102 may be communicatively coupled to a database 110 that may include a set of parameters corresponding to a business, that are needed to be achieved in order to achieve a goal. The database 110 may be updated periodically with a new set of parameters corresponding to a business. The set of parameters corresponding to the business may include a measure for success, a measure for expenses, a measure for competition, a measure for market effectiveness, a measure for investment, a measure for goal income, and a measure for progress. Additionally, the process plan creation and tracking device 102 may be communicatively coupled to an external device 112 via network 114 for sending and receiving various data. Examples of the external device 112 may include, but is not limited to, a remote server, digital devices, and a computer system. The network 114 may correspond to a communication network. The communication network 114, for example, may be any wired or wireless communication network and the examples may include, but may be not limited to, the Internet, Wireless Local Area Network (WLAN), Wi-Fi, Long Term Evolution (LTE), Worldwide Interoperability for Microwave Access (WiMAX), and General Packet Radio Service (GPRS). In some embodiments, the database 110 may be directly coupled to the process plan creation and tracking device 102. In some other embodiments, the database 110 may be coupled to the process plan creation and tracking device 102 via the network 114.

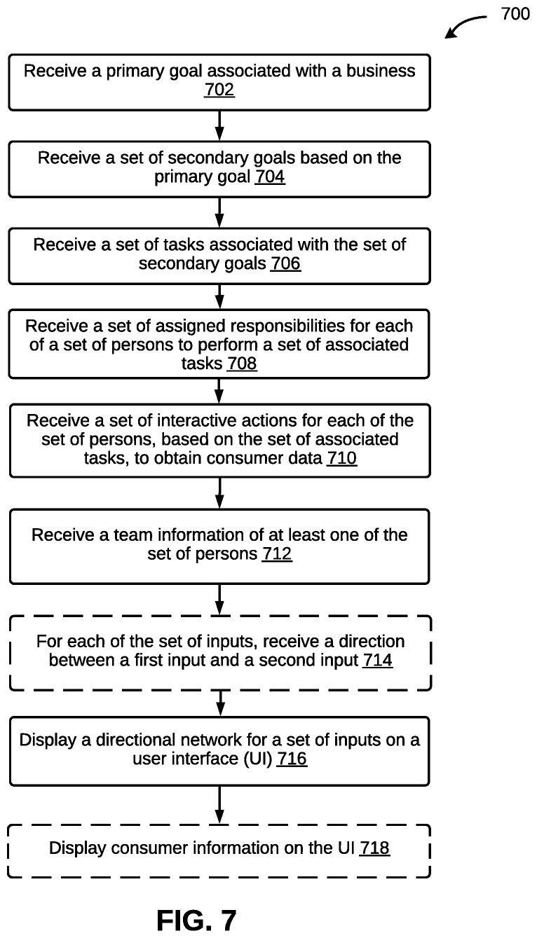

Referring now to FIG. 2A, a block diagram 200A of various modules 206-214 within the memory 108 of the process plan creation and tracking device 102 is illustrated, in accordance with some embodiments of the present disclosure. The process plan creation and tracking device 102, may act as an interactive interface for providing a complete view of an occupational model. The memory 108 may interact with the first user interface 202 and the second user interface 204 associated with the process plan creation and tracking device 102. The second user interface 204 may include a plurality of nodes. This may be explained in detail in conjunction with FIGS. 7-14. The memory 108 includes a process entity creation module 206, a node creation module 208, entity selection module 210, a node annotation module 212, and a link creation module 214.

The process entity creation module 206 may be configured to receive an input from the first user interface 202 to create a process entity. The process entity may be selected from, but not limited to, a goal-type entity, an interaction-type entity, a process-type entity, a responsibility-type entity, a role-type entity, a task-type entity, and a team-type entity. The process entity creation module 206 may be communicatively coupled to the node creation module 208. The node creation module 208 may be configured to create a node corresponding to the process entity via the second user interface 204. The node may be selected from, but not limited to, a goal-type node, an interaction-type node, a process-type node, a responsibility-type node, a role-type node, a task-type node, and a team-type node. The second User-Interface 204 includes the plurality of nodes.

For example, in some embodiments, the memory 108 may include various sub-modules including a goal type module, a sub-goal type module, a task type module, an interaction type module, a role and responsibility module, and a team type module (not-shown in FIG. 2A). This may be explained in conjunction with FIG. 2B.

Further, the entity selection module 210 may be configured to receive an input to select an entity. The entity selection module 210 may be coupled to the process entity creation module 206 and node annotation module 212. Further, the node annotation module 212 may receive an attribute associated with the selected entity. Based on the attribute, the node annotation module 212, may annotate a node corresponding to the selected entity. In some embodiments, metadata corresponding to each of the plurality of nodes may be determined.

The link creation module 214 may be configured for creating a link between two nodes. In other words, the node creation may create a link between a first node and a second node. For example creating links between the node corresponding to get patient better from back pain and the node corresponding to identity of illness. In some embodiments, the link creation module 214 may receive selection of the first node and selection of the second node may be received via the second user interface 204 to generate a link between the nodes. Further, the link creation module 214 may define direction of the link between the first node and the second node upon receiving direction data.

By way of an example, in some embodiments, an entity dataset may be created in the database 110 (shown in FIG. 1) based on the process entity created by the process entity creation module 206. The entity dataset may be updated with the attribute data, link data and direction data. Additionally, a position data associated with a position of the node may be stored in the second User-Interface, with the corresponding entity dataset when the node is created by the node creation module. It should be noted that a new position or reposition of the node may be stored in the second user interface

To securely access the nodes, the process plan creation and tracking device 102 may ask for a user authentication. A successful user authentication may allow the user to annotate the node, generate the link between the first node and the second node, receive the direction input associated with the link, and reposition the node at the new position, based on the repositioning input.

Referring now to FIG. 2B, a block diagram of a system 200B for creating and modifying an occupational model is illustrated, in accordance with some embodiments of the present disclosure. The system 200B may include various modules within the memory 108 configured to work together. The memory 108 may include a user interface (s) (UI) 202b, a goal type module 204b, a sub-goal type module 206b, a task type module 208b, an interaction type module 210b, a role and responsibility module 212b, and a team type module 214b. In some embodiments, the goal type module 204b may receive a primary goal from the UI 202b. In some embodiments, the primary goal may be a core objective associated with a business. The core objective may correspond to a reason that may provide monetary benefits in return for producing and selling of products and services associated to a particular business. In some exemplary scenarios, the primary goal associated with a hospital may correspond to healing back pain of a patient. It should be noted that in such scenarios, the hospital may generate revenue by providing services to the patient. Once a goal associated to a business is determined, the sub-goal type module 206b may receive a set of secondary goals associated with the primary goal from the UI 202b. It should be noted that each of the set of secondary goals may be required to be accomplished, in order to achieve the primary goal. Some examples of the set of secondary goals associated with an exemplary primary goal of healing the back pain of a patient may include, but is not limited to, to learn key clinical data and medical history of the patient, to identify a reason for the back pain, to identify treatment for the back pain, to identify conservative back treatment details, and to identify surgical back treatment details.

Based on the set of secondary goals associated with the primary goal, the task type module 208b, may receive a set of tasks from the UI 202b, associated with the set of secondary goals. It should be noted that each of the set of tasks may be required to be performed in order to achieve the set of secondary goals. In some embodiments, each of the set of tasks may include a plurality of secondary tasks that may be required to be completed, in order to complete the set of tasks. In some embodiments, the set of tasks may include, but is not limited to, gathering key clinical and medical history of the patient, diagnosing the back pain, diagnosing stages of the back pain, gathering treatment drivers and scoring treatment options for the back pain, gathering treatment details and drivers, evaluating the drivers and defining the treatment details, testing and identifying drivers to define treatment in detail, and evaluating the drivers and defining the treatment in detail.

Additionally, based on the set of tasks, the role and responsibility module 212b may receive information on a set of persons for performing a set of associated tasks from the UI 202b. Further, the role and responsibility module 212b may receive a set of assigned responsibilities for each of the set of persons. Some examples of the set of persons with the set of assigned responsibilities may include a nurse for gathering clinical data and medical history of the patient, a nutritionist for nutrition design for a plurality of patients, a physiotherapist for physiotherapy design for the plurality of patients, and a radiologist for radiography imaging for the plurality of patients. Thereafter, based on the set of tasks, the interaction type module 210b may receive consumer data based on a communication performed between an individual and a business professional from the UI 202b. By way of an example, the individual may correspond to a patient and the business professional may correspond to a doctor or a nurse. In some embodiments, the consumer data may include a name, an age, a weight, a height, and a cause of illness of the patient.

Moreover, in some embodiments, the interaction type module 210b may be a part of the UI 202b. In such embodiments, a patient information may be displayed on left side of the UI 202b. Additionally, in such embodiments, the UI 202b may display a form on right side to capture the consumer data based on a communication between the patient and the doctor or the nurse by the input/output device 104. Further, the team type module 214b may receive a team information of at least one of the set of persons from the UI 202b. It should be noted that the set of persons may be divided into a plurality of teams based on the set of assigned responsibilities and the set of associated tasks for each of the set of persons. It should also be noted that the process plan creation and tracking device 102 may be capable of monitoring progress of the business at a level of the primary goal determined by the goal type module 204b, and at a level of secondary goals determined by the sub-goal type module 206b.

It should be noted that, the process plan creation and tracking device 102 may be implemented in programmable hardware devices such as programmable gate arrays, programmable array logic, programmable logic devices, or the like. Alternatively, the system 100 and associated process plan creation and tracking device 102 may be implemented in software for execution by various types of processors. An identified engine/module of executable code may, for instance, include one or more physical or logical blocks of computer instructions which may, for instance, be organized as a component, module, procedure, function, or other construct. Nevertheless, the executables of an identified engine/module need not be physically located together but may include disparate instructions stored in different locations which, when joined logically together, comprise the identified engine/module and achieve the stated purpose of the identified engine/module. Indeed, an engine or a module of executable code may be a single instruction, or many instructions, and may even be distributed over several different code segments, among different applications, and across several memory devices.

As will be appreciated by one skilled in the art, a variety of processes may be employed for creating and dynamically tracking a process plan. For example, the exemplary system 100 and associated process plan creation and tracking device 102 may create the process plan, by the process discussed herein. In particular, as will be appreciated by those of ordinary skill in the art, control logic and/or automated routines for performing the techniques and steps described herein implemented by the system 100 and the associated process plan creation and tracking device 102 either by hardware, software, or combinations of hardware and software. For example, suitable code may be accessed and executed by the one or more processors on the system 100 to perform some or all of the techniques described herein. Similarly, application specific integrated circuits (ASICs) configured to perform some or all the processes described herein may be included in the one or more processors on the system 100.

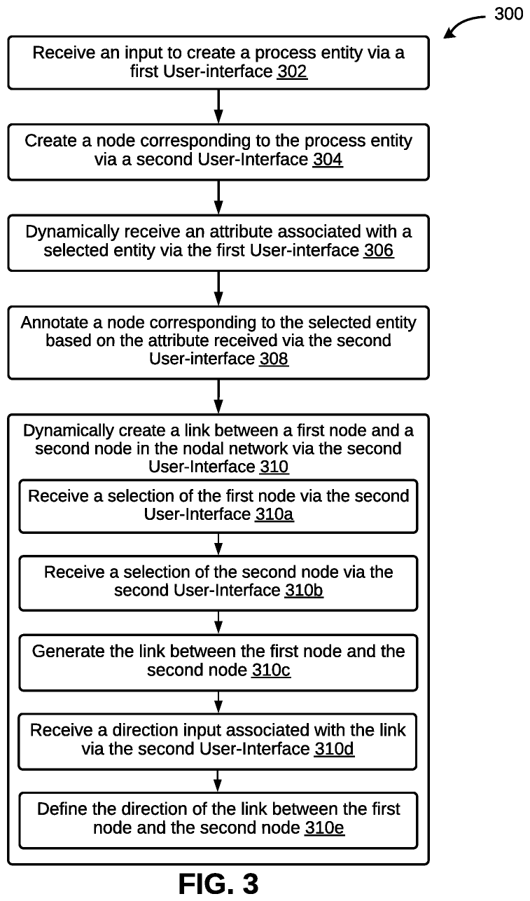

Referring now to FIG. 3, a method for creating and dynamically tracking a process plan is depicted via a flow diagram 300, in accordance with some embodiments of the present disclosure. Each step of the process may be performed by a process plan creation and tracking device 102 (similar to the process plan creation and tracking device 102). FIG. 3 is explained in conjunction with FIGS. 1-2.

At step 302, an input to create a process entity may be received using a first user interface (same as the first user interface 202). The process entity may be a goal-type entity, an interaction-type entity, a process-type entity, a responsibility-type entity, a role-type entity, a task-type entity, and a team-type entity. At step 304, a node may be created. The node may be a node corresponding to the process entity. A type of the node may be one of a goal-type, an interaction-type, a process-type, a responsibility-type, a role-type, a task-type, and a team-type Also, the second user interface may include a plurality of nodes.

At step 306, an attribute associated with a selected entity may be received dynamically. Further, at step 308, a node corresponding to the selected entity may be annotated. The annotation may be performed based on the attribute received.

A link between a first node and a second node in the nodal network may be created, at step 310. In order to create the link various steps 310a-310e may be performed. At step 310a, a selection of the first node may be received. At step 310b, a selection of the second node may be received. At step 310c, the link between the first node and the second node may be generated. At step 310d, a direction input associated with the link may be received. At step 310e, the direction of the link between the first node and the second node may be defined.

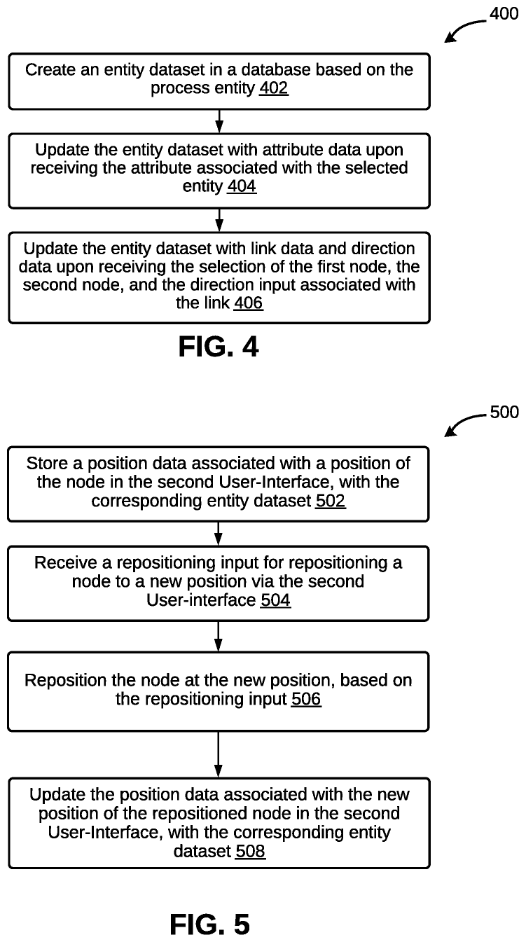

Referring now to FIG. 4, a method for creating and updating an entity dataset is depicted via a flow diagram 400, in accordance with some embodiments of the present disclosure. At step 402, an entity dataset may be created based on the process entity. The entity dataset may be created in a database (same as the database 110). At step 404, the entity dataset may be updated with attribute data when the attribute associated with the selected entity is received. Further, the entity dataset may be updated with link data and direction data upon receiving the selection of the first node, the second node, and the direction input associated with the link, at step 406.

Referring now to FIG. 5, a method for storing position data is depicted via a flow diagram 500, in accordance with some embodiments of the present disclosure. At step 502, a position data associated with a position of the node may be stored in the second user interface with the corresponding entity dataset, in response to creation of the node. At step 504, a repositioning input may be received via the second user interface in order to reposition a node to a new position. Further, at step 506, based on the repositioning input, the node may be repositioned at the new position. At step 508, the position data associated with the new position of the repositioned node may be stored in the second User-Interface with the corresponding entity dataset, in response to repositioning of the node.

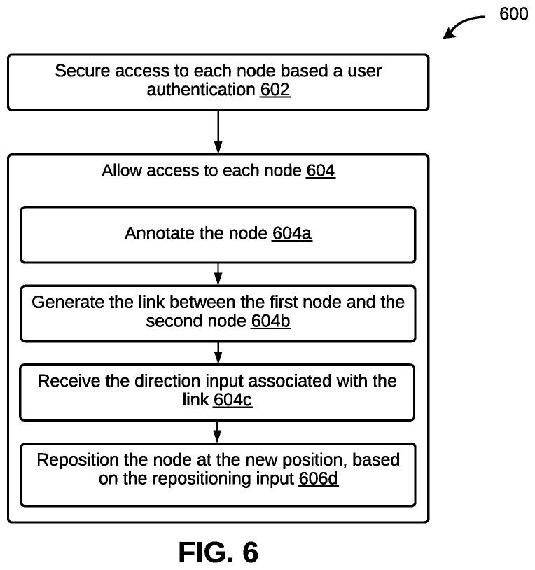

Referring now to FIG. 6, a method for providing secure user access to nodes is depicted via a flow diagram 600, in accordance with some embodiments of the present disclosure. At step 602, access to each node may be secured based on the user authentication. Further, at step 604, access to each node may be allowed upon successful user authentication. Further, at step 604a, permission to annotate the node may be allowed. At step 604b, permission to generate the link between the first node and the second node may be allowed. At step 604c, a permission to receive direction input associated with the link may be allowed. At step 604d, a permission to reposition the node at the new position, based on the repositioning input may be allowed.

Referring now to FIG. 7, a flow diagram of a method 700 for creating and dynamically tracking an occupational model is illustrated, in accordance with some embodiments of the present disclosure. At step 702, a primary goal associated with a business may be received by the process plan creation and tracking device 102. Further, the method 700 may include receiving a set of secondary goals based on the primary goal, at step 704. At step 706, the method 700 may include receiving a set of tasks associated with the set of secondary goals. Each of the set of tasks may correspond to a plurality of secondary tasks as explained in conjunction to FIG. 2B. Further, the method 700 may include receiving a set of assigned responsibilities for each of a set of persons to perform a set of associated tasks, at step 708. At step 710, a set of interactive actions may be received for each of the set of persons, based on the set of associated tasks, to obtain consumer data. As already explained in conjunction to FIG. 2, the set of interactive action may include a communication between an individual and a business professional. At step 712 of the method 700, a team of at least one of the set of persons may be received. At step 714, the method 700 may include receiving a direction between a first input and a second input to obtain the directional network, for each of a set of inputs. It should be noted that the set of inputs may include the primary goal, the set of secondary goals, the set of persons, the set of tasks, the team of at least one of the set of persons, and for each of the set of persons, the set of assigned responsibilities and the set of interactive actions. It should also be noted that the first input and the second input belong to the set of inputs. At step 716, a directional network for the set of inputs on a user interface (UI) may be displayed. Further, at step 718 of the method 700, a consumer information may be displayed on the UI. In some embodiments, the consumer information includes a set of open tasks, a set of available tasks, a set of completed tasks, a feedback, and the consumer data.

It may therefore be understood that standalone business process modeling tools and the ones that come with Business Process Management (BPM) engines are used to describe the processes, sub-processes and tasks/steps in the process. The goals are not identified separately, but are sometimes seen through the lens of the steps/tasks that help achieve them.

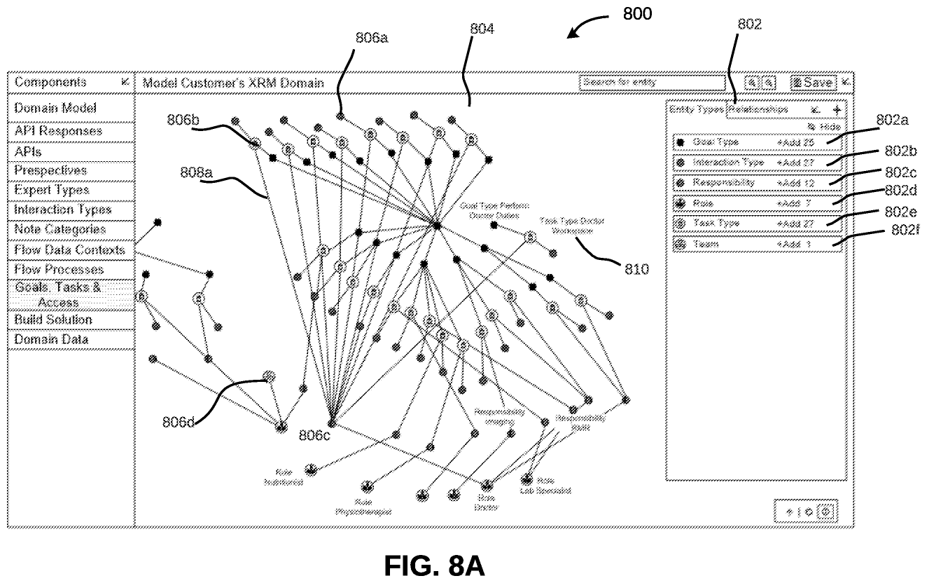

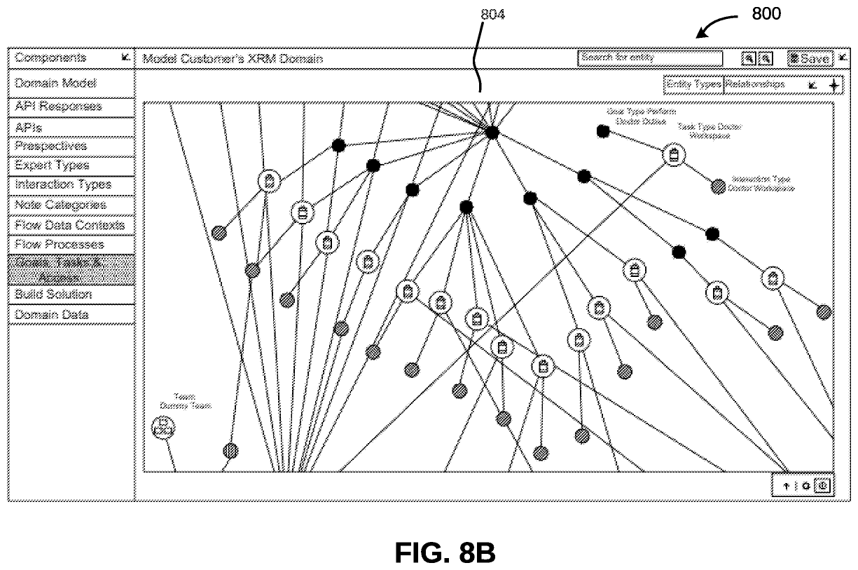

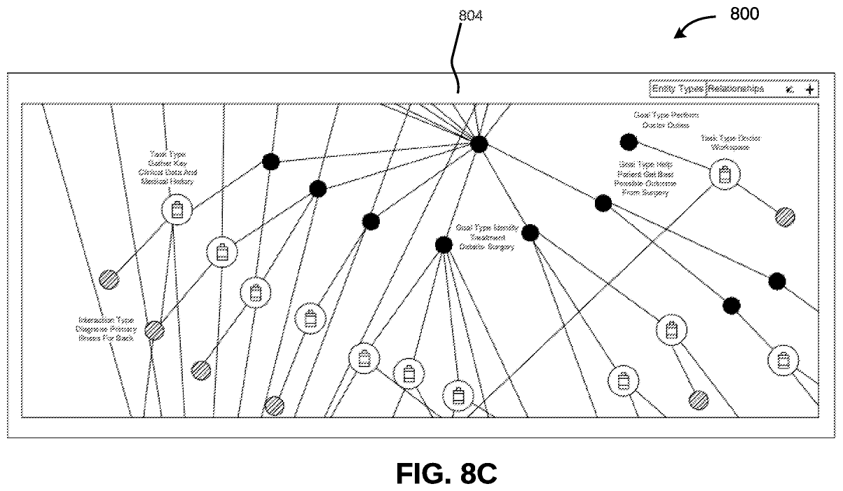

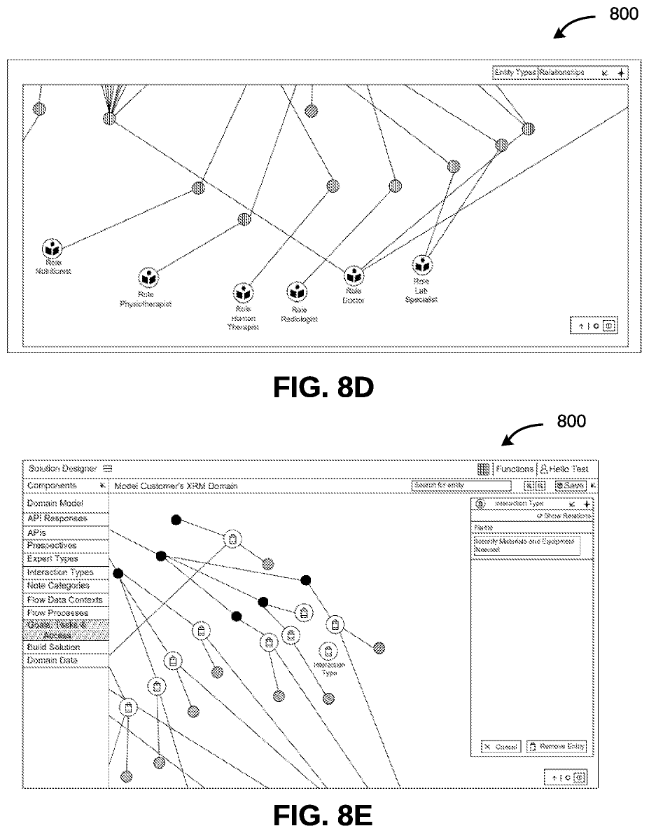

In other words, the method 700 may include creating a process plan having one or more hierarchical levels, such as a level-1, a level-2, a level-3, and so on as illustrated in FIG. 8A. It may be noted that the hierarchical levels may not be limited to three levels (level-1, level-2, and level-3) and may include lower or higher number of hierarchical levels as well. The method may further include creating a plurality of entities. It may be noted that each of the one or more hierarchical levels may further include one or more entities. For example, the level-1 may include a first level-1 entity, a second level-1 entity, a third level-1 entity, and so on. Similarly, the level-2 may include a first level-2 entity, a second level-2 entity, a third level-2 entity, and so on. In some embodiments, the one or more entities belonging to the one or more hierarchical levels may be interlinked.

The method 700 may include receiving an entity-input corresponding to each of the one or more entities. The method may further include receiving a link-input corresponding to each of the one or more interlinks that exist between the one or more entities belonging to the one or more hierarchical levels.

By way of an example, a level-1 entity-input received corresponding to first level-1 entity may include “treat back pain” (i.e., a text input). This first level-1 entity may act as a goal of the process plan. Further, a first level-2 entity-input and a second level-2 entity-input may be received corresponding to each of a first level-2 entity and a second level-2 entity. The first level-2 entity-input may include “medical intervention” and the second level-2 entity-input may include “physical exercise”. The first level-2 entity-input and the first level-2 entity-input may at as sub-goals.

Further, a first level-3 entity-input, a second level-3 entity-input, and a third level-3 entity-input may be received corresponding to each of a first level-3 entity, a second level-3 entity, and a third level-3 entity. The first level-3 entity-input may include “surgery”, and the second level-3 entity-input may include “oral medicine”. The third level-3 entity-input may include “weight training”. The first level-3 entity-input, the second level-3 entity-input, and the third level-3 may act as roles (or tasks) of the process plan.

It may be understood that the first level-3 entity-input (“surgery”) and the second level-3 entity-input (“oral medicine”) are related to the first level-2 entity-input (“medical intervention”). As such, the first level-3 entity-input (“surgery”) and the second level-3 entity-input (“oral medicine”) may be linked to the first level-2 entity-input (“medical intervention”). Similarly, the third level-3 entity-input (“weight training”) is related to the second level-2 entity-input (“physical exercise”), and, therefore, may be linked with each other.

The entire process plan may be displayed via a user interface (s) 800. In some embodiments, the one or more hierarchical levels i.e., the level-1, a level-2, a level-3, etc. The one or more entities associated with the one or more hierarchical levels may be represented as nodes 806 (for example, a node 806a, a node 806b, a node 806c) of a network in a second user interface 804. Further, the nodes 806 of the network may be inter-linked. For example, sub-goals or roles corresponding to one goal may be linked to sub-goals or roles corresponding to another goal. It may be noted that by way of creating the plurality of entities among the one or more hierarchical levels, the process plan may be created that may act as a blueprint of the business plan for future. In some embodiments, the link 808a or relationship between two entities (corresponding to nodes 806b and 806c) may be defined. For example, a link between a task and a sub goal may be defined at “contributes to”, i.e., the task contributes towards execution of the goal (i.e., achieving a business objective). Further, this process plan is updated as the business model is executed over time.

In other words, the level-1 entities (goals), the level-2 entities (sub-goals), and the level-3 entities (roles), may be displayed via the second user interface. An exemplary user interface 800 is illustrated via FIGS. 8A-8E. As shown in FIG. 8A, the second user interface 804 may include a plurality of nodes (representing entities). The plurality of nodes 806 may be divided into level-1 entities (goals), level-2 entities (sub-goals), and level-3 entities (roles). The second user interface 800, therefore, displays a holistic view of the entire process plan (i.e., business plan) in form of a graphical representation in a single page. The holistic view of the entire process may show different entities, i.e., goals, sub-goals, and roles, and how these different entities are interrelated. As it can be seen in the FIG. 8A, sub-goals and roles corresponding to one goal may be linked to sub-goals and roles corresponding to another goal, i.e., interrelated. Further, a first user interface 802 displays entity types including a goal type 802a, an interaction type 802b, a responsibility 802c, a role 802d, a task type 802e, a team 802f. FIGS. 8B-8C show magnified views of the user-interface (s) 800. The user interface (s) allows a user to create this holistic view by simply picking and choosing through the multiple layers/levels of different entities (i.e. goals, subgoals, roles and responsibilities). In other words, the various entities are created beforehand by coding, such that the user may picking and choosing from these pre-build entities to create the process plan, without having to code themselves.

In some embodiments, the interactive interface 800 may be analogous to the UI 202b. In some other embodiments, the first user interface and the second user interface 802 and 804 may be similar to the first user interface 202 and the second user interface 204. By way of an example, the exemplary interactive interface 800 may represent an occupational model for a hospital. In some embodiments, the executable business model for the hospital may include a primary goal (a core objective of the hospital) which may be required to generate revenue. Further, the primary goal may correspond to healing the back pain of the patient. Based on the primary goal of the hospital to heal the back pain of the patient, a set of secondary goals may be received by the process plan creation and tracking device 102 from the UI 202b. It should be noted that the set of secondary goals may contribute to achieving the primary goal of the hospital. Examples of the set of secondary goals may include, but are not limited to, gathering key clinical data and medical history of the patient, identifying the reason for the back pain, identifying the treatment for the back pain, identifying the conservative back treatment details, and identifying the surgical back treatment details. Thereafter, based on the set of secondary goals, the process plan creation and tracking device 102 may receive a set of tasks for accomplishing the set of secondary goals, so as to eventually achieve the primary goal of the hospital. By way of example, the set of tasks may include, but is not limited to, gathering key clinical and medical history of the patient, diagnosing reasons for the back pain, diagnosing stages of the back pain, gathering treatment drivers and score treatment options for back pain, gathering treatment details drivers, and testing and identifying drivers to define the treatment in detail. Additionally, based on the set of tasks, the process plan creation and tracking device 102 may receive the set of persons with the set of assigned responsibilities for performing the set of associated tasks from the UI 202b. In an embodiment, in order to perform a “gathering clinical data and medical history” task, a nurse may be assigned a responsibility for gathering clinical data and medical history of the patient. Examples of a set of persons with an assigned responsibility for performing the set of tasks may include, but are not limited to, a nurse for gathering clinical data and medical history, a nutritionist for nutrition design, a physiotherapist for physiotherapy design, and a radiologist for radiography imaging. Thereafter, based on the set of tasks, the consumer data may be captured based on an interaction between an individual and a business professional. By way of an example, the individual may correspond to a patient and the business professional may correspond to a doctor or a nurse. The consumer data may include a name, an age, a weight, a height, and a cause of illness of the patient.

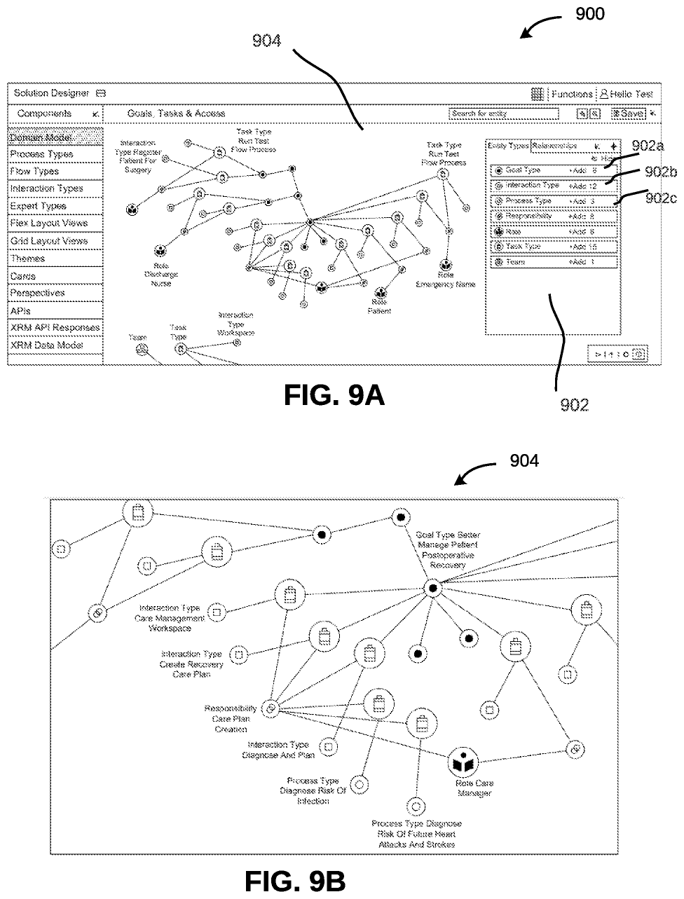

Referring now to FIG. 9A, a user interface (s) 900 representing a process plan is shown. The user interface (s) 900 may include a second user interface 904 to display the process plan. As shown in the FIG. 9A, the process plan may include a plurality of entities. A first user interface 902 of the user interface (s) 900 may include one or more fields (on the right end of the user interface) using which the plurality of entities can be dynamically updated. FIG. 9B shows a magnified view of the process plan on the second user interface 904. It may be noted that, as shown in FIG. 9B, the second user interface 904 may allow adding a “process type 902c” entity, and an “interaction type 902b” entity. For example, a “process type 902c” entity may include “diagnosing risk of infection” or “diagnosing risk of heart attacks and strokes”, and an “interaction type 902b” entity may include “diagnose and plan”. It may be noted that the “process type 902c” entity may correspond to a function that may be associated with a group of entities. The “interaction type” entity may correspond to a function that may be associated with an individual entity.

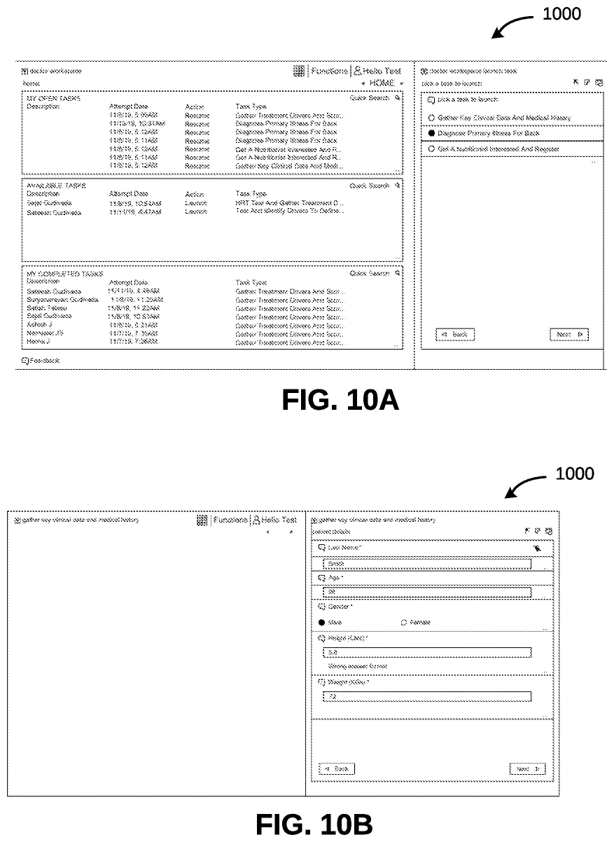

Referring now to FIG. 10A, an exemplary interactive interface 1000 (analogous to the user interactive 800) displaying consumer information is illustrated, in accordance with some embodiments of the present disclosure. The interactive interface 1000 may include, on the left side, a consumer section displaying the consumer data. It should be noted that the consumer information may be essential for performing an interaction between a business and a consumer. In an embodiment, the consumer information may include the set of open tasks, the set of available tasks, the set of completed tasks, the feedback, and the consumer data. A right side of the interactive interface 1000 may include the set of associated tasks required to drive the interaction. The set of tasks may include, but is not limited to, gathering clinical data and medical history of the patient, diagnosing the reasons for back pain, getting a nutritionist interested and registered, and the like.

Referring now to FIG. 10B, the exemplary interactive interface 1000 for receiving consumer information is illustrated, in accordance with some embodiments of the present disclosure. By way of an example, the interactive interface 1000 may be used to drive an interactive action based on a communication performed between a patient and a nurse to capture the consumer data for a new patient. The consumer data may include, but is not limited to, a name, an age, a weight, a height, and a cause of illness of the patient.

It may be noted that once the process plan is created, a provision may be provided for dynamically tracking execution of tasks, dynamically tracking progress on individual goals, and correspondingly updating the goals and tasks. By way of an example, each of the plurality of the entities created as part of the process plan may be dynamically updated, as the process plan is executed over time. For example, an authorized user may update status of one or more entities. This provides a flexibility of dynamically editing the initial process plan (i.e., blueprint). As such, a synchronization is maintained between the initial process plan and the current state of the process plan due to the updates that take place during the execution of the process plan.

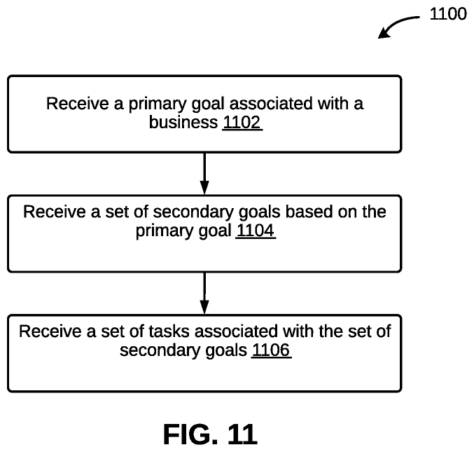

To this end, a method 1100 for modifying an occupational model (also, referred to as “process plan” within this disclosure) is illustrated in FIG. 11, in accordance with some embodiments of the present disclosure. The method 1100 may include receiving a set of additional inputs in the directional network to obtain a modified directional network, at step 1102. It should be noted that a type of each of the set of additional inputs may include at least one of a primary goal, a set of secondary goals, a set of persons, a set of tasks, a team of at least one of the set of persons, and for each of the set of persons, a set of assigned responsibilities and a set of interactive actions. Additionally, for each of the set of additional inputs, a direction between a first additional input and a second additional input may be received to obtain the modified directional network, at step 1104. It should be noted that the first additional input and the second additional input may belong to the set of additional inputs. Further, the method 1100 may include displaying the extended directional network for the set of additional inputs on the UI 202b, at step 1106.

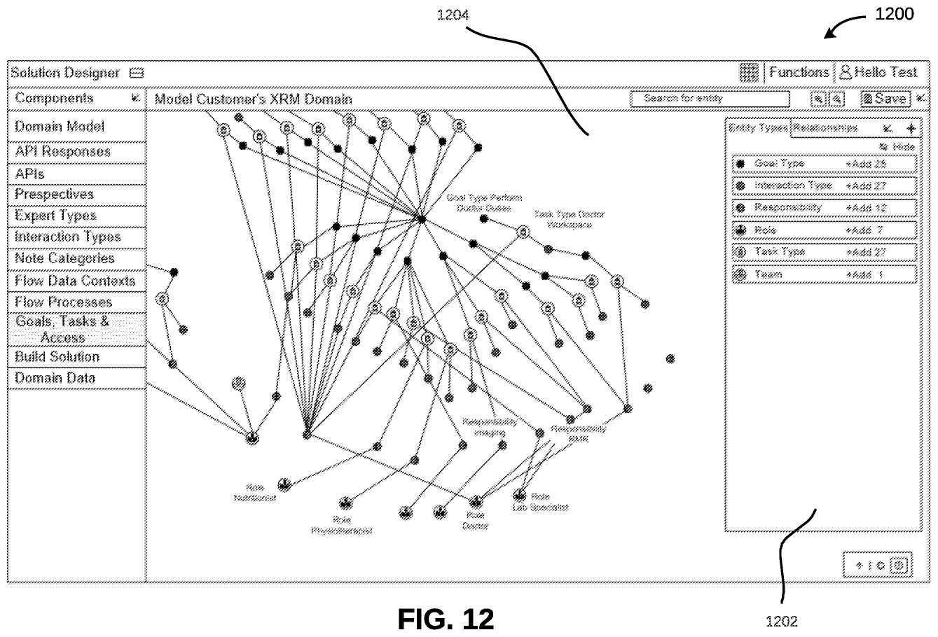

Referring now to FIG. 12, an exemplary interactive interface 1200 (analogous to the user interface 800) for providing a set of additional inputs to an occupational model is illustrated, in accordance with some embodiments of the present disclosure. The interactive interface includes a first user interface 1202 and a second user interface 1204 comprising nodal network. In some embodiments, a user may select at least one of a set of additional inputs from the right side (from the first user interface 802) of the interactive interface 1200. By way of example, a type of each of the set of additional inputs may be one of a primary goal, a set of secondary goals, a set of persons, a set of tasks, a set of assigned responsibilities, or a team information. It should be noted that each of the set of additional inputs may be added to the directional network in order to obtain the modified directional network.

Going back to FIG. 2B, each of the set of additional inputs may be received by the system 200B through an associated module. For example, the primary goal may be received by the goal type module 204b, the set of secondary goals may be received by the sub-goal type module 206b, the set of tasks may be received by the task type module 208b, the set of interactive actions for each of the set of persons may be received by the interaction type module 210b, the set of persons and the set of assigned responsibilities for each of the set of persons may be received by the role and responsibility module 212b, and the team information of at least one of the set of persons may be received by the team type module 214b.

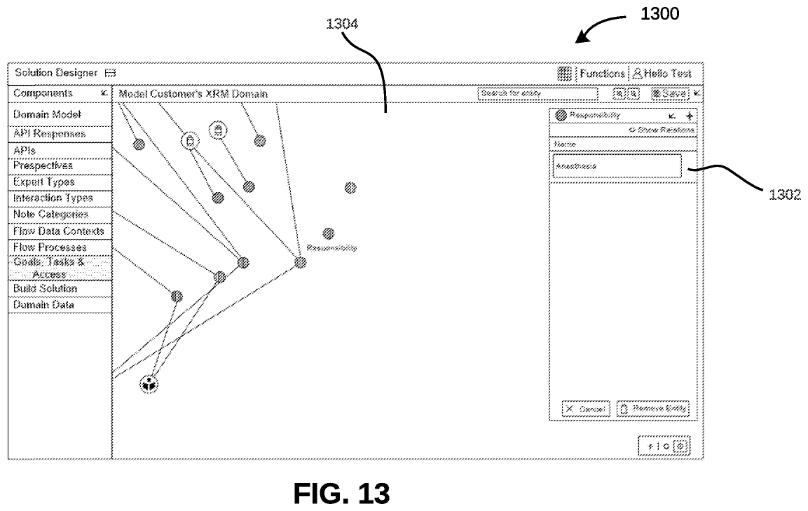

Referring now to FIG. 13, an exemplary interactive interface 1300 (analogous to user interface 800) for providing details of one of the set of additional inputs in an occupational model is illustrated, in accordance with some embodiments of the present disclosure. The interactive interface includes a first user interface 1302, and a second user interface 1304. It should be noted that the details for one of the set of additional inputs may be received from the user via a first user interface 1302. It may be noted that the user may first be securely authenticated in order to receive the details for the inputs. For example, the authentication may be performed via a username/password. In some other embodiments, the authentication may be of any type.

One or more techniques are described for creating and dynamically tracking execution of tasks, dynamically tracking progress on individual goals, and correspondingly updating the goals and tasks. The techniques are based on a concept of business model elements (Goals, Sub-Goals, Tasksbacked by Processes and Interactions) for describing a business model with connections between these business model elements to describe how they work together in contributing to one another in achieving the business objectives. Further, the techniques provide for a graphical, to be specific, Graph (Nodes and Directed Edges) Designer or Directed Graph based representation of entities and relationships between them, to capture and depict a holistic and connected business model on a single page. Further, the business model is used to drive the run-time execution of the business systems. The techniques provide for a structured way of defining, setting, and tracking progress at Goal level and Sub-Goal level, in a structured way, so as to be sure about the real progress: Goal progress. The techniques provide for connecting the business model to the security model on the same Graphical/Graph Designer to provide right grained access control, and an easy way to understand visualization of connections between security model and rest of the business model.

The techniques provide for a convenient way of creating a process plan via a user interface. The techniques further provide for a combined capability of defining a process plan (i.e., a business model) and dynamically tracking execution of tasks, dynamically tracking progress on individual goals, and correspondingly updating the goals and tasks. The techniques further provide a user interface through which different entities related to the process plan are represented via nodes. This provides a visualization of connections between a security model and rest of the business model which is easy to understand. By way of this user interface, in complex business models having multiple goals and tasks, individual goals, sub-goals and roles can be created and tracked easily. Moreover, as different goals, sub-goals, and tasks may be interrelated, the techniques provide a holistic view of the business model, and therefore, an easy and effective way of creating a process plan and dynamically tracking the progress on multiple goals of the process plan. Further, security and access control are directly connected into the business model which provides for a robust way to secure the business.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, although individually listed, a plurality of means, elements or process steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

What is claimed is:

1. A method of creating a process plan, the method comprising:
receiving, via a first User-interface, an input to create a process entity, wherein the process entity is one of a goal-type entity, an interaction-type entity, a process-type entity, a responsibility-type entity, a role-type entity, a task-type entity, and a team-type entity;
creating, via a second User-Interface, a node corresponding to the process entity, wherein the node is one of a goal-type node, an interaction-type node, a process-type node, a responsibility-type node, a role-type node, a task-type node, and a team-type node, wherein the second User-Interface comprises a plurality of nodes;
dynamically receiving, via the first User-interface, an attribute associated with a selected entity;
annotating, via the second User-interface, a node corresponding to the selected entity based on the attribute received; and
dynamically creating, via the second User-Interface, a link between a first node and a second node in a nodal network, wherein creating the link comprises:
receiving, via the second User-Interface, a selection of the first node;
receiving, via the second User-Interface, a selection of the second node;
generating the link between the first node and the second node;
receiving, via the second User-Interface, a direction input associated with the link; and
defining the direction of the link between the first node and the second node.

2. The method of claim 1 further comprising:
creating an entity dataset in a database based on the process entity;
upon receiving the attribute associated with the selected entity, updating the entity dataset with attribute data; and
upon receiving the selection of the first node, the second node, and the direction input associated with the link, updating the entity dataset with link data and direction data.

3. The method of claim 1 further comprising:
upon creating the node, storing a position data associated with a position of the node in the second User-Interface, with a corresponding entity dataset.

4. The method of claim 3 further comprising:
receiving a repositioning input, via the second User-interface, for repositioning a node to a new position;
repositioning the node at the new position, based on the repositioning input; and
upon repositioning the node, updating the position data associated with the new position of the repositioned node in the second User-Interface, with the corresponding entity dataset.

5. The method of claim 1 further comprising:
securing access to each node based a user authentication.

6. The method of claim 5, wherein a successful authentication allows access to each node, wherein allowing access to each node comprises allowing permission to:
annotate the node;
generate the link between the first node and the second node;
receive the direction input associated with the link; and
reposition the node at a new position, based on the repositioning input.

7. A system for creating a process plan, the system comprising:
a processor; and
a memory communicatively coupled to the processor, wherein the memory stores processor-executable instructions, which, on execution, cause the processor to:
receive, via a first User-interface, an input to create a process entity, wherein the process entity is one of a goal-type entity, an interaction-type entity, a process-type entity, a responsibility-type entity, a role-type entity, a task-type entity, and a team-type entity;
create, via a second User-Interface, a node corresponding to the process entity, wherein the node is one of a goal-type node, an interaction-type node, a process-type node, a responsibility-type node, a role-type node, a task-type node, and a team-type node, wherein the second User-Interface comprises a plurality of nodes;
dynamically receive, via the first User-interface, an attribute associated with a selected entity;
annotate, via the second User-interface, a node corresponding to the selected entity based on the attribute received; and
dynamically create, via the second User-Interface, a link between a first node and a second node in the nodal network, wherein creating the link comprises:
receive, via the second User-Interface, a selection of the first node;
receive, via the second User-Interface, a selection of the second node;
generate the link between the first node and the second node;
receive, via the second User-Interface, a direction input associated with the link; and
define the direction of the link between the first node and the second node.

8. The system of claim 7, wherein the processor-executable instructions further cause the processor to:
create an entity dataset in a database based on the process entity;
upon receiving the attribute associated with the selected entity, update the entity dataset with attribute data; and
upon receiving the selection of the first node, the second node, and the direction input associated with the link, update the entity dataset with link data and direction data.

9. The system of claim 7, wherein the processor-executable instructions further cause the processor to:
upon creating the node, store a position data associated with a position of the node in the second User-Interface, with the corresponding entity dataset.

10. The system of claim 9, wherein the processor-executable instructions further cause the processor to:
receive a repositioning input, via the second User-interface, for repositioning a node to a new position;
reposition the node at the new position, based on the repositioning input; and
upon repositioning the node, update the position data associated with the new position of the repositioned node in the second User-Interface, with the corresponding entity dataset.

11. The system of claim 7, wherein the processor-executable instructions further cause the processor to:
secure access to each node based a user authentication.

12. The system of claim 11, wherein the processor-executable instructions further cause the processor to allow access to each node by allowing permission to:
annotate the node;
generate the link between the first node and the second node;
receive the direction input associated with the link; and
reposition the node at a new position, based on the repositioning input.

13. A non-transitory computer-readable medium storing computer-executable instructions for creating a process plan, the computer-executable instructions configured for:
receiving, via a first User-interface, an input to create a process entity, wherein the process entity is one of a goal-type entity, an interaction-type entity, a process-type entity, a responsibility-type entity, a role-type entity, a task-type entity, and a team-type entity;
creating, via a second User-Interface, a node corresponding to the process entity, wherein the node is one of a goal-type node, an interaction-type node, a process-type node, a responsibility-type node, a role-type node, a task-type node, and a team-type node, wherein the second User-Interface comprises a plurality of nodes;
dynamically receiving, via the first User-interface, an attribute associated with a selected entity;
annotating, via the second User-interface, a node corresponding to the selected entity based on the attribute received; and
dynamically creating, via the second User-Interface, a link between a first node and a second node in a nodal network, wherein creating the link comprises:
receiving, via the second User-Interface, a selection of the first node;
receiving, via the second User-Interface, a selection of the second node;
generating the link between the first node and the second node;
receiving, via the second User-Interface, a direction input associated with the link; and
defining the direction of the link between the first node and the second node.

14. The non-transitory computer-readable medium of claim 13, wherein the computer-executable instructions further configured for:
creating an entity dataset in a database based on the process entity;
upon receiving the attribute associated with the selected entity, updating the entity dataset with attribute data; and
upon receiving the selection of the first node, the second node, and the direction input associated with the link, updating the entity dataset with link data and direction data.

15. The non-transitory computer-readable medium of claim 13, wherein the computer-executable instructions further configured for:
upon creating the node, storing a position data associated with a position of the node in the second User-Interface, with the corresponding entity dataset.

16. The non-transitory computer-readable medium of claim 15, wherein the computer-executable instructions further configured for:
receiving a repositioning input, via the second User-interface, for repositioning a node to a new position;
repositioning the node at the new position, based on the repositioning input; and
upon repositioning the node, updating the position data associated with the new position of the repositioned node in the second User-Interface, with the corresponding entity dataset.

17. The non-transitory computer-readable medium of claim 13, wherein the computer-executable instructions further configured for:
securing access to each node based a user authentication.

18. The non-transitory computer-readable medium of claim 17, wherein the computer-executable instructions further configured for allowing access to each node comprises allowing permission to:
annotate the node;
generate the link between the first node and the second node;
receive the direction input associated with the link; and
reposition the node at the new position, based on the repositioning input.
